(19) United States
(12) Patent Application Publication
(10) Pub. No.: US 2013/0229060 A1
(43) Pub. Date: Sep. 5, 2013

(54) MULTI POWER SUPPLY SYSTEM

(71) Applicants: KUO-HSIANG CHANG, Tu-Cheng (TW); YU-CHI TSAI, Tu-Cheng (TW)

(72) Inventors: KUO-HSIANG CHANG, Tu-Cheng (TW); YU-CHI TSAI, Tu-Cheng (TW)

(73) Assignee: HON HAI PRECISION INDUSTRY CO., LTD., Tu-Cheng (TW)

(21) Appl. No.: 13/590,444

(22) Filed: Aug. 21, 2012

(30) Foreign Application Priority Data
Mar. 1, 2012 (TW) 101106832

(51) Int. Cl. H02J 1/00; H02J 9/00

(52) U.S. Cl. 307/64; 307/66; 307/80; 307/82

(57) ABSTRACT

A multi power supply system includes a power supply, a power source, a control unit, a first conversion unit, and first and second switch elements. The control unit provides a timing signal indicative of a duty cycle to the first conversion unit. The first conversion unit provides an output voltage according to the duty cycle and an output voltage of the power source, so the multi power supply determines whether the first switch unit or the second switch unit is turned on according to the output voltage of the first conversion unit. Thus, the power supply and the power source can alternately supply power for the multi power supply system.

### BACKGROUND

1. Technical Field

The present disclosure relates to a power system, and particularly to a multi power supply system.

2. Description of Related Art

A multi power supply system uses surge protectors, such as electromagnetic relays, to switch between power sources. If a solar cell module is one of the power sources, the solar cell module can supply power when an amount of light absorption is large enough for the solar cell module. However, light absorption on the solar cell module is unstable so that an output voltage of the solar call module is also unstable. Therefore, the surge protectors of the multi power supply system switch frequently in a high operating voltage between the solar cell module and the other power sources, which easily induces oxidation of contacts in the surge protectors. Since the oxidation of the contacts will influence the switches between the power sources, stability of the multi-power supply system will be decreased.

Therefore, there is need for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a power system of the present disclosure.

FIG. 2 is a part circuit diagram of the power system in FIG. 1.

### DETAILED DESCRIPTION

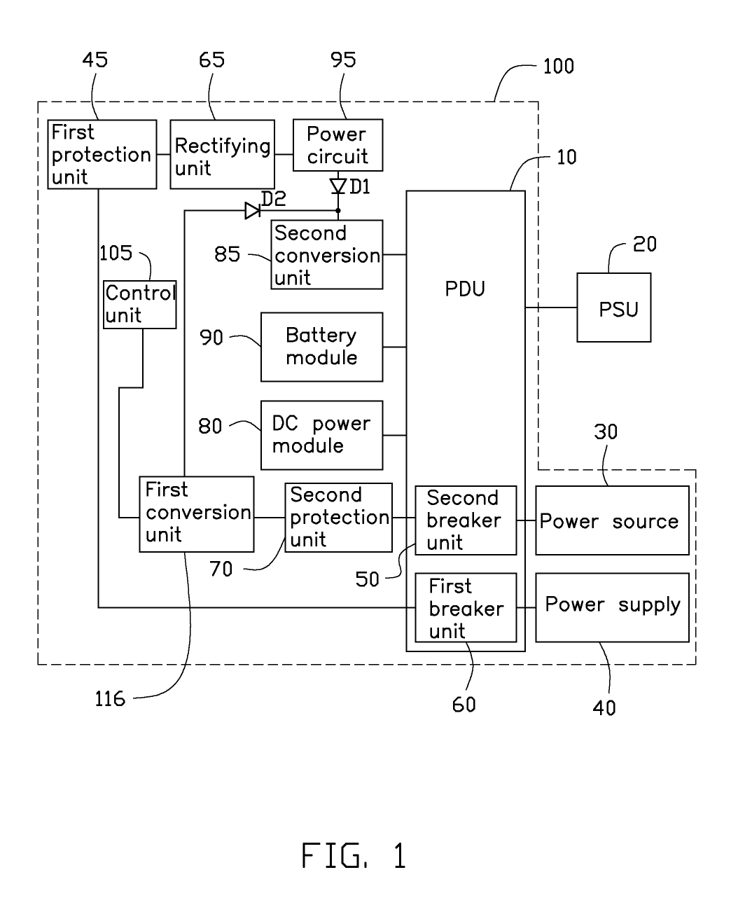

FIG. 1 illustrates an embodiment of a power system 100 of the present disclosure. The power system 100 is a multi power supply system and supplies power to a power supply unit (PSU) 20 of a server. The power system 100 includes a power supply 40, a power source 30, a power distribution unit (PDU) 10, a second protection unit 70, a first conversion unit 116, a direct current (DC) power module 80, a battery module 90, a second conversion unit 85, a control unit 105, a power circuit 95, a rectifying unit 65, a first protection unit 45, a first switch element D1, and a second switch element D2. The PDU 10 further includes a first breaker unit 60 and a second breaker unit 50. In the embodiment, the first and the second protection units 45 and 70 are surge protectors, the first conversion unit 116 is a boost converter, the rectifying unit 65 is a rectifier, a power circuit 95 is a power factor correction (PFC) circuit, the second conversion unit 85 is a buck converter, and the first and the second breaker unit 60 and 50 are breakers.

The power supply 40 is connected to a first terminal of the first switch element D1 through the first breaker unit 60, the first protection unit 45, the rectifying unit 65, and the power circuit 95. A second terminal of the first switch element D1 is connected to a first input terminal of the PDU 10 through the second conversion unit 85. The power source 30 is connected to a first terminal of the second switch element D2 through the second breaker unit 50, the second protection unit 70, and the first conversion unit 116. A second terminal of the second switch element D2 is connected to the second terminal of the first switch element D1. The battery module 90 is connected to a second input terminal of the PDU 10, and the DC power module 80 is connected to a third input terminal of the PDU 10. An output terminal of the PDU 10 is connected to an input terminal of the PSU 20.

In the embodiment, the first and the second protection units 45 and 70 are electromagnetic relays. The first and the second protection units 45 and 70 are turned off on condition that there is a surge current or an overvoltage in a circuit of the power system 100. If there is no surge current and overvoltage in the power system 100, the first and the second protection units 45 and 70 are turned on. In addition, the first and the second breaker units 60 and 50 protect the power system 100 from an overcurrent. Thus, the first and the second breaker units 60 and 50 and the first and the second protection units 45 and 70 are installed in the power system 100 for protection, if necessary.

The power supply 40 is an alternating current (AC) power supply. In the embodiment, the power supply 40 is connected to a mains supply. The AC power supply can be a single phase AC power supply or a multi phase AC power supply, such as a three phase AC power supply. The rectifying unit 65 converts an AC voltage of the power supply 40 to a DC voltage, and the power circuit 95 increases a power factor of the DC voltage transmitted from the rectifying unit 65 to provide a first voltage to the first terminal of the first switch element D1.

The second conversion unit 85 converts the first voltage transmitted from the power circuit 95 into a converted voltage. The converted voltage is provided to the first input terminal of the PDU 10.

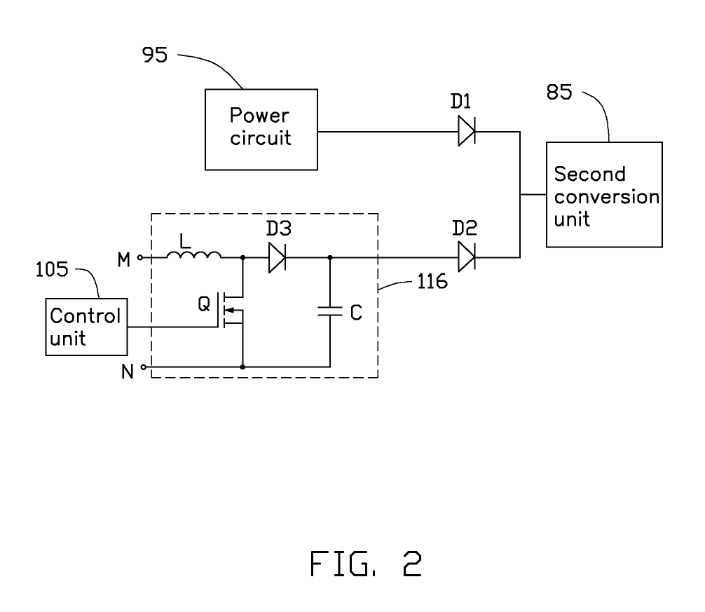

FIG. 2 illustrates a part circuit of the power system 100 of the present disclosure. The first conversion unit 116 includes a first input terminal M, a second input terminal N, an inductive element L, a third switch element D3, a fourth switch element Q, and a capacitive element C. The first and the second input terminals M and N of the first conversion unit 116 connect to the second protection unit 70 to receive a second voltage from the power source 30. In the embodiment, the first input terminal M receives an input voltage and the second input terminal N receives a ground voltage. Thus, the second voltage of the first conversion unit 116 received from the power protection unit 70 is a voltage between the input voltage of the first input terminal M and the ground voltage of the second input terminal N. A first terminal of the fourth switch element Q is connected to the control unit 105, a second terminal of the fourth switch element Q is connected to the first input terminal M through the inductive element L, and a third terminal of the fourth switch element Q is grounded through the second input terminal N. A first terminal of the third switch element D3 is connected to the second terminal of the fourth switch element Q, and a second terminal of the third switch element D3 is connected to the first terminal of the second switch element D2 and grounded through the capacitive element C. In the embodiment, the inductive element L is an inductor, the first, the second and the third switch elements D1-D3 are diodes, the first terminals of the diodes are anodes, the second terminals of the diodes are cathodes, the fourth switch element Q is a field effect transistor (FET), the first terminal of the FET is a gate, the second terminal of the FET is a drain, the third terminal of the FET is a source, and the capacitive element is a capacitor. In addition, the power source 30 is a solar cell module and converts solar energy to provide the second voltage.

The control unit 105 transmits a timing signal to the first conversion unit 116 to adjust a third voltage of the first conversion unit 116 according to the timing signal. The timing signal includes information about a duty cycle. The duty cycle can be preset in the range of 0 to 1 by a user according to electrical properties of the power source 30 to fully utilize solar energy. In the embodiment, the duty cycle is not larger than 50%. The duty cycle is pre-set according to a relation equation between the second voltage and the third voltage, Vout/Vin=1/(1−D), wherein Vout is an output voltage of the first conversion unit 116, i.e. the third voltage, Vin is an input voltage of the first conversion unit 116, i.e. the second voltage, and D is the duty cycle received by the first conversion unit 116. The first conversion unit 116 provides the third voltage to the first terminal of the second switch element D2. In the embodiment, the third voltage is larger than or equal to the second voltage according to the relation equation.

If the first voltage provided by the power circuit 95 is a first voltage value, such as 390 volts, and the duty cycle provided by the control unit 105 is 50%, the second voltage of the power source 30 can be one-half of the first voltage, such as 195 volts, according to the relation equation when the third voltage is equal to the first voltage. When the second voltage provided by the power source 30 is larger than one-half of the first voltage, the third voltage converted from the second voltage by the first conversion unit 116 is larger than the first voltage. For example, the third voltage can be 400 volts. Therefore, the second switch element D2 is turned on and the first switch element D1 is turned off, since the third voltage of the first conversion unit 116 is larger than the first voltage of the power circuit 95. Thus, the third voltage is received by the second conversion unit 85 while the first voltage is not received by the second conversion unit 85. On the contrary, the third voltage converted from the second voltage is smaller than the first voltage when the second voltage provided by the power source 30 is smaller than one-half of the first voltage. Therefore, the second switch element D2 is turned off and the first switch element D1 is turned on. The first voltage is received by the second conversion unit 85 but not the third voltage. In addition, the third voltage is equal to the first voltage when the second voltage is equal to one-half of the first voltage. Therefore, both of the first and second switch elements D1 and D2 are turned on so that the first voltage and the third voltage are received by the second conversion unit 85 to supply power at the same time.

In the embodiment, the power source 30 is a solar cell module. Thus, the power source 30 has an open-circuit voltage when there is no external load connected to the power source 30. Since the open-circuit voltage of the solar cell module is a maximum voltage of the solar cell module, the open-circuit voltage must be larger than the second voltage. If the third voltage converted from the second voltage is smaller than the first voltage, there is still possibility that a fifth voltage converted from the open-circuit voltage by the first conversion unit 116 may be larger than the first voltage.

When the third voltage is smaller than the first voltage, the second switch element D2 is turned off and the first switch element D1 is turned on. The power circuit 95 provides the first voltage to the second conversion unit 85 through the first switch element D1, and the solar cell module loses its external load and provides the open-circuit voltage. If the fifth voltage is larger than the first voltage, the first switch element D1 will be turned off and the second switch element D2 will be turned on. The first conversion unit 116 provides the fifth voltage to the second conversion unit 85 through the second switch element D2, and the solar cell module reconnects to its external load and provides the second voltage. Since the third voltage converted from the second voltage is smaller than the first voltage, the second element D2 will be turned off and the first element D1 will be turned on again. The power circuit 95 provides the first voltage to the second conversion unit 85 again through the first switch element D1. Thus, the first and the second switch elements D1 and D2 can be alternately and periodically turned on since the power source 30 alternately provides the second voltage and the open-circuit voltage. In the embodiment, a time interval between the second voltage and the open-circuit voltage is controlled by a capacitance of the capacitive element.

When the light intensity is too little for the solar cell module to provide a voltage larger than the first voltage, the third voltage will be smaller than the first voltage. However, the power source 30 of the power system 100 can still supply power when the power source 30 provides the open-circuit voltage. Accordingly, the power source 30 can supply power to the PSU 20 even if the light intensity is too little for the solar cell module. In addition, the power supply 40 of the power system 100 can supply power when the light intensity is too little, so the power supply 40 can compensate for insufficient power of the power source 30.

The second conversion unit 85 is connected to the second terminals of the first and the second switch elements D1 and D2. The second conversion unit 85 transmits a fourth voltage to the PDU 10 for supplying power according to a received voltage of the second conversion unit 85. When the first voltage is larger than the third voltage, the second conversion unit 85 receives the first voltage to convert to the fourth voltage. When the first voltage is smaller than the third voltage, the second conversion unit 85 receives the third voltage to convert to the fourth voltage. Therefore, the fourth voltage is determined by comparing the first voltage with the third voltage.

The battery module 90 and the DC power module 80 are standby power sources for the power system 100. When the power supply 40 and the power source 30 are broken down and stop supplying power, the battery module 90 and the DC power module 80 can replace the power supply 40and the power source 30 to supply power to the PDU 10. Therefore, the power system 100 can be an uninterruptible power supply (UPS) system. In the embodiment, the DC power module 80 can be a power system of another server, which is the same as the power system 100 of the present disclosure. The battery module 90 and the DC power module 80 can directly provide a standby DC voltage to the PDU 10 to supply power to the PSU 20.

The power system 100 can preset the duty cycle of the first conversion unit 116 and automatically adjust the output voltage of the first conversion unit 116 according to the duty cycle and the output voltage of the power source 30. Therefore, the first and the second switch units D1 and D2 can be turned off or turned on so that the power supply 40 and the power source 30 can alternately supply power to the PDU 10. Thus, it is unnecessary the power supply 40 and the power source 30 are turned on or off by the first and the second protection units 45 and 70. The first and the second protection units 45 and 70 can be turned on continuously to prevent oxidation of contacts of the first and the second protection units 45 and 70. Moreover, the power supply 40 can supply power to the PDU 10 without switching off the first conversion unit 116 so the stability of the power system 100 is increased. In addition, utilization rate of the solar energy is increased since the power supply 40 and the power source 30 can alternately or simultaneously supply power to the PDU 10.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A power system for supplying power, comprising:
a power circuit connecting to a power supply to provide a first voltage to a first terminal of a first switch element;
a power source configured to provide a second voltage;
a control unit configured to provide a timing signal;
a first conversion unit configured to receive the timing signal and the second voltage, to convert the second voltage to a third voltage according to the timing signal, and to provide the third voltage to a first terminal of a second switch element, wherein the first switch element is turned off and the second switch element is turned on when the third voltage is larger than the first voltage, and the second switch element is turned off and the first switch element is turned on when the third voltage is smaller than the first voltage; and
a second conversion unit connected to the second terminals of the first and the second switch elements to receive the first voltage when the first switch element is turned on, to receive the third voltage when the second switch element is turned on, and to transmit a fourth voltage according to at least one of the first voltage and the third voltage for supplying power.

2. The power system of claim 1, further comprising:
a rectifying unit configured to convert an alternating current (AC) voltage of the power supply to a direct current (DC) voltage, wherein the power circuit converts the DC voltage to the first voltage.

3. The power system of claim 2, further comprising:
a first protection unit connecting the power supply to the rectifying unit, the first protection unit to be turned off when receiving one of a surge current and an overvoltage; and
a second protection unit connecting the power source to the first conversion unit, the second protection unit to be turned off when receiving one of the surge current and the overvoltage.

4. The power system of claim 3, wherein the first conversion unit further comprises an inductive element, a third switch element, a fourth switch element, a capacitive element, a first input terminal, and a second input terminal, the first and the second input terminals are connected to the second protection unit, a first terminal of the fourth switch element is connected to the control unit, a second terminal of the fourth switch element is connected to the first input terminal through the inductive element and to a first terminal of the third switch element, the second input terminal and a third terminal of the fourth switch element are grounded, and a second terminal of the third switch element is grounded through the capacitive element and connected to the first terminal of the second switch element.

5. The power system of claim 4, wherein the first conversion unit is a boost converter, the rectifying unit is a rectifier, the first and the second protection units are surge protectors, the inductive element is an inductor, the first, the second and the third switch elements are diodes, the first terminals of the diodes are anodes, the second terminals of the diodes are cathodes, the fourth switch element is a field effect transistor (FET), the first terminal of the FET is a gate, the second terminal of the FET is a drain, the third terminal of the FET is a source, and the capacitive element is a capacitor.

6. The power system of claim 2, further comprising:
a power distribution unit configured to receive the fourth voltage to supply power; and
a standby power source configured to supply power to the power distribution unit when the power supply stops providing the AC voltage and the power source stops providing the second voltage.

7. The power system of claim 6, wherein the power distribution unit further comprises a breaker unit to connect the power supply to the rectifying unit for an overcurrent protection.

8. The power system of claim 6, wherein the standby power source is one of a DC power module and a battery module.

9. The power system of claim 1, wherein the power source is a solar cell module and converts solar energy to provide the second voltage.

10. The power system of claim 9, wherein the second voltage is an open-circuit voltage of the solar cell module when the second switch element is turned off.

11. The power system of claim 10, wherein the power supply and the power source alternately supply power to generate the fourth voltage when the first voltage is smaller than a fifth voltage converted from the open-circuit voltage by the first conversion unit.

12. The power system of claim 1, wherein the timing signal is indicative of a duty cycle, and the duty cycle is pre-set to control the third voltage.

13. The power system of claim 12, wherein the duty cycle is pre-set according to an equation, the equation is Vout/Vin=1/(1−D), Vout is an output voltage of the first conversion unit, Vin is an input voltage of the first conversion unit, and D is the duty cycle.

14. A power system for supplying power, comprising:
a power circuit configured to provide a first voltage through a power supply to a first terminal of a first switch element;
a control unit configured to provide a timing signal;
a first conversion unit configured to receive the timing signal and a second voltage through a power source, to convert the second voltage to a third voltage according to the timing signal, and to provide the third voltage to a first terminal of a second switch element, wherein the second terminal of the first switch element is connected to the second terminal of the second switch element; and
a power distribution unit configured to receive a fourth voltage to supply power, wherein the fourth voltage is determined by comparing the first voltage with the third voltage.

15. The power system of claim 14, further comprising:
a rectifying unit configured to convert an alternating current (AC) voltage of the power supply to a direct current (DC) voltage, wherein the power circuit converts the DC voltage to the first voltage; and
a second conversion unit connected to the second terminals of the first and the second switch elements to receive the first voltage when the first voltage is larger than the third voltage, to receive the third voltage when the first voltage is smaller than the third voltage, and to transmit the fourth voltage according to at least one of the first voltage and the third voltage.

16. The power system of claim 15, wherein the first switch element is turned off and the second switch element is turned on when the first voltage is smaller than the third voltage, and the second switch element is turned off and the first switch element is turned on when the first voltage is larger than the third voltage.

17. The power system of claim 14, wherein the power source is a solar cell module and converts solar energy to provide an output voltage, and a protection unit receives the output voltage to provide the second voltage.
